(19) United States
(12) Patent Application Publication
(10) Pub. No.: US 2016/0049637 A1
(43) Pub. Date: Feb. 18, 2016

(54) POSITIVE ELECTRODE FOR RECHARGEABLE LITHIUM BATTERY AND METHOD OF PREPARING SAME, NEGATIVE ELECTRODE FOR RECHARGEABLE LITHIUM BATTERY AND METHOD OF PREPARING SAME

(71) Applicant: SAMSUNG SDI CO., LTD., Yongin-si (KR)

(72) Inventors: Ju-Hee SOHN, Yongin-si (KR); Jin-Hyon LEE, Yongin-si (KR); Jung-Yeon WON, Yongin-si (KR); Eun-Young GOH, Yongin-si (KR); Jong-Ki LEE, Yongin-si (KR); Sang-In PARK, Yongin-si (KR)

(21) Appl. No.: 14/742,756

(22) Filed: Jun. 18, 2015

(30) Foreign Application Priority Data
Aug. 13, 2014 (KR) 10-2014-0105345

(51) Int. Cl. H01M 4/13; H01M 4/04

(52) U.S. Cl. CPC H01M 4/13; H01M 4/0404; H01M 4/043; H01M 2004/028

(57) ABSTRACT

Provided are a positive electrode and a negative electrode for a rechargeable lithium battery. For example, the positive electrode includes a current collector; and a positive active material layer on the current collector. The positive active material layer has a first region adjacent to the current collector and a second region separated from the current collector by the first region, each of the first region and second region having a thickness equal to ½ of a total thickness of the positive active material layer. The first region has a first average pore size, and the second region has a second average pore size. A ratio of the second average pore size to the first average pore size is greater than about 0.5 and less than or equal to about 1.0. The positive electrode has an active mass density of about 2.3 g/cc to about 4.5 g/cc.

### CROSS-REFERENCE TO RELATED APPLICATION

Korean Patent Application No. 10-2014-0105345, filed on Aug. 13, 2014, in the Korean Intellectual Property Office, and entitled: “Positive Electrode for Rechargeable Lithium Battery and Method of Preparing Same, Negative Electrode for Rechargeable Lithium Battery and Method of Preparing Same,” is incorporated by reference herein in its entirety.

### BACKGROUND

1. Field

A positive electrode and a negative electrode for a rechargeable lithium battery and a method of preparing the same are disclosed.

2. Description of the Related Art

Increasing electrochemical energy of an electrode of a rechargeable lithium battery having the same density may provide long term use. For example, a high-density electrode may be manufactured by coating a more active material per unit area on a current collector, and then compressing it to decrease its volume.

### SUMMARY

Embodiments may be realized by providing a positive electrode for a rechargeable lithium battery, including a current collector; and a positive active material layer on the current collector. The positive active material layer has a first region adjacent to the current collector and a second region separated from the current collector by the first region, each of the first region and second region having a thickness equal to ½ of a total thickness of the positive active material layer. The first region has a first average pore size, and the second region has a second average pore size. A ratio of the second average pore size to the first average pore size is greater than about 0.5 and less than or equal to about 1.0. The positive electrode has an active mass density of about 2.3 g/cc to about 4.5 g/cc.

The first average pore size may be about 20 nm to about 1000 nm, and the second average pore size may be about 10 nm to about 1000 nm.

A ratio of a porosity of the second region to a porosity of the first region may be greater than about 0.5 and less than or equal to about 1.0.

A porosity of the first region may be about 5 volume % to about 40 volume %, and a porosity of the second region may be about 5 volume % to about 40 volume %.

Embodiments may be realized by providing a method of preparing a positive electrode for a rechargeable lithium battery, including coating a positive active material layer composition on a current collector to obtain a coated product; drying the coated product to obtain a dried product; and compressing the dried product in a multistep compression, the multistep compression providing different active mass densities of the positive electrode following each compression and a final active mass density of the positive electrode of about 2.3 g/cc to about 4.5 g/cc.

The multistep compression may include increasing the active mass density of the positive electrode with successive compressions.

Embodiments may be realized by providing a negative electrode for a rechargeable lithium battery, including a current collector; and a negative active material layer on the current collector. The negative active material layer has a first region adjacent to the current collector and a second region separated from the current collector by the first region, each of the first region and second region having a thickness equal to ½ of a total thickness of the negative active material layer. The first region has a first average pore size, and the second region has a second average pore size. A ratio of the second average pore size to the first average pore size being greater than about 0.5 and less than or equal to about 1.0. The negative electrode has an active mass density of about 1.1 g/cc to about 2.29 g/cc.

The first average pore size may be about 20 nm to about 1000 nm, and the second average pore size may be about 10 nm to about 1000 nm.

A ratio of a porosity of the second region to a porosity of the first region may be greater than about 0.5 and less than or equal to about 1.0.

A porosity of the first region may be about 5 volume % to about 40 volume %, and a porosity of the second region may be about 5 volume % to about 40 volume %.

Embodiments may be realized by providing a method of preparing a negative electrode for a rechargeable lithium battery, including coating a negative active material layer composition on a current collector to obtain a coated product; drying the coated product to obtain a dried product; and compressing the dried product in a multistep compression, the multistep compression providing different active mass densities of the negative electrode following each compression and a final active mass density of the negative electrode of about 1.1 g/cc to about 2.29 g/cc.

The multistep compression may include increasing active mass density of the negative electrode with successive compressions.

### BRIEF DESCRIPTION OF THE DRAWINGS

Features will become apparent to those of skill in the art by describing in detail exemplary embodiments with reference to the attached drawings in which:

FIG. 1 illustrates a schematic view of a rechargeable lithium battery according to an embodiment;

FIGS. 2 to 4 illustrate scanning electron microscope (SEM) photographs inside the negative electrodes for a rechargeable lithium battery according to Example 1, Example 2 and Comparative Example 1;

FIG. 5 illustrates a graph of impregnation properties of an electrolyte solution for the negative electrodes for a rechargeable lithium battery according to Examples 1 and 2 and Comparative Example 1;

FIGS. 6 and 7 illustrate scanning electron microscope (SEM) photographs inside the positive electrodes for a rechargeable lithium battery according to Example 3 and Comparative Example 2;

FIGS. 8 and 9 illustrate scanning electron microscope (SEM) photographs inside the positive electrodes for a rechargeable lithium battery according to Example 4 and Comparative Example 3;

FIGS. 10 and 11 illustrate scanning electron microscope (SEM) photographs inside the positive electrodes for a rechargeable lithium battery according to Example 5 and Comparative Example 4;

FIG. 12 illustrates a graph of pore distribution inside the positive electrodes for a rechargeable lithium battery according to Example 5 and Comparative Example 4;

FIG. 13 illustrates a graph of impregnation properties of an electrolyte solution for the positive electrodes for a rechargeable lithium battery according to Examples 3 to 5 and Comparative Examples 2 to 4;

FIG. 14 illustrates a graph of cycle-life characteristics of the rechargeable lithium battery cells according to Example 1 and Comparative Example 1; and

FIG. 15 illustrates a graph of cycle-life characteristics of the rechargeable lithium battery cells according to Example 3 and Comparative Example 2.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

Hereinafter, a positive electrode for a rechargeable lithium battery according to an embodiment is described.

The positive electrode may include a current collector and a positive active material layer positioned on the current collector. The current collector may include, for example, aluminum.

The positive electrode may have an active mass density of about 2.3 g/cc to about 4.5 g/cc, for example, about 2.35 g/cc to about 4.2 g/cc. A high-density positive electrode having an active mass density within such range may have an internally uniform pore structure. For example, the positive electrode may have not have a large difference in the internal pore structure in a surface region and a region close to a current collector, and may have an internally uniform pore structure. An embodiment may provide a positive electrode having internal uniformity, for example, a positive electrode having an internally uniform pore structure by preparing a high-density positive electrode in a multistep compression method. The multistep compression method will be described later.

The positive electrode internally may have a uniform pore structure, impregnation characteristics of an electrolyte into the high-density electrode may be remarkably improved, and cycle-life characteristics of a rechargeable lithium battery may be improved.

For example, the positive active material layer according to an embodiment may include a first region and a second region. The first region may be adjacent to the current collector and the second region may be separated from the current collector by the first region. Each of the first region and second region may have a thickness equal to ½ of a total thickness of the positive active material layer.

The positive active material layer may include pores, for example, in the positive active material layer. The first region may have at least one first pore and the second region may have at least one second pore. The first region may have a first average pore size, and the second region may have a second average pore size.

The first average pore size may be about 20 nm to about 1000 nm, for example, about 50 nm to about 200 nm. The second average pore size may be about 10 nm to about 1000 nm, for example, about 20 nm to about 1000 nm, or about 50 nm to about 200 nm. Maintaining the first and second average pore sizes within such ranges may help provide a positive electrode having high active mass density, and such a high-density positive electrode may have a uniform pore structure inside the positive electrode.

Average pore size is defined as a gap size among particles which may be formed when the particles are packed. The average pore size may be measured in a mercury porosimetry or BET method.

For example, a ratio of the second average pore size to the first average pore size (i.e., the second average pore size÷the first average pore size) may be greater than about 0.5 and less than or equal to about 1.0, for example, greater than about 0.7 and less than or equal to about 1.0. Maintaining a ratio of the second average pore size to the first average pore size within the range may help provide a positive electrode having a uniform pore structure, and such a positive electrode may realize a rechargeable lithium battery having excellent cycle-life characteristics, for example, due to extremely good impregnation characteristics of an electrolyte.

The porosity of the first region may be about 5 volume % to about 40 volume %, for example, about 15 volume % to about 30 volume %. The porosity of the second region may be about 5 volume % to about 40 volume %, for example, about 15 volume % to about 30 volume %. Maintaining the porosities of the first region and the second region within such ranges may help provide a positive electrode having high active mass density, and such a high-density positive electrode may have a uniform pore structure inside the positive electrode.

Porosity is defined as a percentage of the volume of pores based on the total volume of each first and second region. The porosity may be measured in a mercury porosimetry or BET method.

For example, a ratio of the porosity of the second region to the porosity of the first region (i.e., the porosity of the second region÷the porosity of the first region) may be greater than about 0.5 and less than or equal to about 1.0, for example, greater than about 0.7 and less than or equal to about 1.0. Maintaining the ratio of the porosity of the second region to the porosity of the first region within such range may help provide a positive electrode having a uniform pore structure, and such a positive electrode may realize a rechargeable lithium battery having excellent cycle-life characteristics, for example, due to extremely good impregnation characteristics of an electrolyte.

The positive active material layer includes a positive active material, and may further include a binder and a conductive material.

The positive active material may be a compound (a lithiated intercalation compound) capable of intercalating and deintercallating lithium, for example, compounds represented by the following chemical formulae.

LiₐA_{1-b}B_{b}D₂ (0.90≦a≦1.8 and 0≦b≦0.5); LiₐE₁₋bB_{b}O_{2-c}D_{c} (0.90≦a≦1.8, 0≦b≦0.5, 0≦c≦0.05); LiₐE_{2-b}B_{b}O_{4-c}D_{c} (0.90≦a≦1.8, 0≦b≦0.5, 0≦c≦0.05); LiₐNi_{1-b-c}Co_{b}B_{c}D_{α} (0.90≦a≦1.8, 0≦b≦0.5, 0≦c≦0.05, 0<α<2); LiₐNi_{1-b-c}Co_{b}B_{c}O_{2-α}F_{α} (0.90≦a≦1.8, 0≦b≦0.5, 0≦c≦0.05, 0<α<2); LiₐNi_{1-b-c}Co_{b}B_{c}O_{2-α}F₂ (0.90≦a≦1.8, 0≦b≦0.5, 0≦c≦0.05, 0<α<2); LiₐNi_{1-b-c}Mn_{b}B_{c}D_{α} (0.90≦a≦1.8, 0≦b≦0.5, 0≦c≦0.05, 0<α≦2); LiₐNi_{1-b-c}Mn_{b}B_{c}O_{2-α}F_{α} (0.90≦a≦1.8, 0≦b≦0.5, 0≦c≦0.05, 0<α<2); LiₐNi_{1-b-c}Mn_{b}B_{c}O_{2-α}F₂ (0.90≦a≦1.8, 0≦b≦0.5, 0≦c≦0.05, 0 <α<2); LiₐNi_{b}E_{c}G_{d}O₂ (0.90≦a≦1.8, 0≦b≦0.9, 0≦c≦0.5, 0.001≦d≦0.1); LiₐNi_{b}Co_{c}Mn_{d}GeO₂ (0.90≦a≦1.8, 0≦b≦0.9, 0≦c≦0.5, 0≦d≦0.5, 0.001≦e ≦0.1); LiₐNiG_{b}O₂ (0.90≦a≦1.8, 0.001≦b≦0.1); LiₐCoG_{b}O₂ (0.90≦a≦1.8, 0.001≦b≦0.1); LiₐMnG_{b}O₂ (0.90≦a≦1.8, 0.001≦b≦0.1); LiₐMn₂G_{b}O₄ (0.90≦a≦1.8, 0.001≦b≦0.1); QO₂; QS₂; LiQS₂; V₂O₅; LiV₂O₅; LiIO₂; LiNiVO₄; Li_{(3-f)}J₂(PO₄)₃(0≦f≦2); Li_{(3-f)}Fe₂(PO₄)₃(0≦f≦2); and LiFePO₄.

In the above chemical formulae, A is Ni, Co, Mn, or a combination thereof; B is Al, Ni, Co, Mn, Cr, Fe, Mg, Sr, V, a rare earth element, or a combination thereof; D is O, F, S, P, or a combination thereof; E is Co, Mn, or a combination thereof; F is F, S, P, or a combination thereof; G is Al, Cr, Mn, Fe, Mg, La, Ce, Sr, V, or a combination thereof; Q is Ti, Mo, Mn, or a combination thereof; I is Cr, V, Fe, Sc, Y, or a combination thereof; and J is V, Cr, Mn, Co, Ni, Cu, or a combination thereof.

Examples of the binder include polyvinyl alcohol, carboxylmethyl cellulose, hydroxypropyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, and nylon.

The conductive material may improve conductivity of an electrode. Any electrically conductive material may be used as a conductive material, unless the electrically conductive material causes a chemical change. Examples thereof include, for example, a carbon-based material such as natural graphite, artificial graphite, carbon black, acetylene black, ketjen black, and carbon fiber; a metal-based material such as, for example, a metal powder or a metal fiber of, for example, copper, nickel, aluminum, and silver; a conductive polymer such as, for example, a polyphenylene derivative; or a mixture thereof.

Hereinafter, a method of preparing a positive electrode for a rechargeable lithium battery according to an embodiment is described. The positive electrode may be prepared according to the following method.

First, the positive active material, the binder and the conductive material may be mixed with a solvent such as N-methylpyrrolidone, preparing a positive active material layer composition. The positive active material layer composition may be coated on the current collector to obtain a coated product, the coated product may be dried to obtain a dried product, and subsequently, the dried product may be compressed in a multistep compression, preparing a high-density positive electrode having the positive active material layer on the current collector.

A high density electrode may be prepared through a single compression, and only the surface region of an electrode rather than the entire surface of the electrode may be pushed down, e.g., compressed. When only the surface region of the electrode is pushed down, e.g., compressed, porosity in the surface region may approach zero, and the electrode may not be easily impregnated with an electrolyte. An electrode prepared though a multistep compression may have decreased differences of average pore size and porosity in the surface region of the electrode and a region adjacent to the current collector, and an overall uniform pore structure. Impregnation characteristic of an electrolyte into the electrode may be improved, and cycle-life characteristics of a battery may be improved.

The multistep compression may be performed not only once but twice or more to obtain a desired active mass density. Every compression maybe be performed to obtain different active mass density, and the final compression may be performed to obtain a desired active mass density. According to an embodiment, the final compression may be performed to obtain an active mass density of about 2.3 g/cc to about 4.5 g/cc.

The multistep compression may include, for example, two to ten compressions, or two to four compressions. As the number of the compressions is increased, the desired active mass density may be increased.

Hereinafter, a negative electrode for a rechargeable lithium battery according to an embodiment is described. The negative electrode may include a current collector and a negative active material layer positioned on the current collector. The current collector may include, for example, a copper foil.

According to an embodiment, a negative electrode may have an active mass density of about 1.1 g/cc to about 2.29 g/cc, for example, about 1.4 g/cc to about 1.95 g/cc. Maintaining the active mass density of the high density negative electrode within such range may help provide an internally uniform pore structure. For example, the negative electrode may not have a large pore structure difference between a surface region and a region close to a current collector, and may have internal uniformity. A high density negative electrode may be prepared to have internal uniformity, for example, an internal uniform pore structure through a multistep compression. The multistep compression method is the same as described above.

The negative electrode may have an internal uniform pore structure, impregnation characteristics of an electrolyte into the high-density electrode may be largely improved, and cycle-life characteristics of a rechargeable lithium battery may be improved.

For example, the negative active material layer according to an embodiment may include a first region and a second region. The first region may be adjacent to the current collector and the second region may be separated from the current collector by the first region. Each of the first region and second region may have a thickness equal to ½ of a total thickness of the negative active material layer.

The negative active material layer may include pores, for example, in the negative active material layer. The first region may have a first average pore size, and the second region may have a second average pore size. Average pore sizes and ratios thereof of the first region and the second region, and a ratio of the porosities of the first region and the second region may be the same as the positive electrode.

The negative active material layer includes a negative active material, and further may include a binder and a conductive material.

The negative active material may be a material that reversibly intercalates/deintercalates lithium ions, a lithium metal, a lithium metal alloy, material capable of doping and dedoping lithium, or transition metal oxide.

The material that reversibly intercalates/deintercalates lithium ions may be a carbon material, for example, a carbon-based negative active material used for a rechargeable lithium battery. Examples thereof include crystalline carbon, amorphous carbon, and a mixture thereof. Examples of the crystalline carbon include graphite, such as amorphous, sheet-shape, flake, spherical shape or fiber-shaped natural graphite or artificial graphite, and examples of the amorphous carbon include soft carbon or hard carbon, a mesophase pitch carbonized product, and fired coke.

The lithium metal alloy may be an alloy of lithium and a metal selected from Na, K, Rb, Cs, Fr, Be, Mg, Ca, Sr, Si, Sb, Pb, In, Zn, Ba, Ra, Ge, Al, and Sn.

The material capable of doping and dedoping lithium may be Si, SiOₓ (0<x<2), a Si—C composite, a Si-Q alloy (wherein, the Q is an element selected from an alkali metal, an alkaline-earth metal, Group 13 to 16 elements, a transition metal, a rare earth element, and a combination thereof, and not Si), Sn, SnO₂, a Sn—C composite, or Sn—R (wherein, the R is an element selected from an alkali metal, an alkaline-earth metal, Group 13 to 16 elements, a transition metal, a rare earth element, and a combination thereof, and not Sn), and at least one of these may be mixed with SiO₂. Examples of Q and R include Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Tl, Ge, P, As, Sb, Bi, S, Se, Te, Po or a combination thereof.

Examples of the transition metal oxide include, for example, vanadium oxide and lithium vanadium oxide.

The binder may improve binding properties of negative active material particles with one another and with a current collector. The binder includes a non-water-soluble binder, a water-soluble binder, or a combination thereof.

In some embodiments, the non-water-soluble binder includes polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, polyamideimide, polyimide, or a combination thereof.

In some embodiments, the water-soluble binder includes a styrene-butadiene rubber, an acrylated styrene-butadiene rubber, polyvinyl alcohol, sodium polyacrylate, a copolymer of propylene and a C2 to C8 olefin, a copolymer of (meth)acrylic acid and (meth)acrylic acid alkyl ester, or a combination thereof.

When the water-soluble binder is used as a negative electrode binder, a cellulose-based compound may be further used to provide viscosity. In some embodiments, the cellulose-based compound includes one or more of carboxylmethyl cellulose, hydroxypropylmethyl cellulose, methyl cellulose, or alkali metal salts thereof. In some embodiments, the alkali metal may be Na, K, or Li. Such a thickener may be included in an amount of about 0.1 parts by weight to about 3 parts by weight based on 100 parts by weight of the negative active material.

The conductive material may improve conductivity of an electrode. Any electrically conductive material may be used as a conductive material, unless the electrically conductive material causes a chemical change. Examples thereof include a carbon-based material such as, for example, natural graphite, artificial graphite, carbon black, acetylene black, ketjen black, and carbon fiber; a metal-based material such as, for example, a metal powder and a metal fiber of, for example, copper, nickel, aluminum, and silver; a conductive polymer such as, for example, a polyphenylene derivative; or a mixture thereof.

The negative electrode may be prepared by mixing the negative active material, the binder and the conductive material in a solvent to prepare a negative active material layer composition, and coating the negative active material layer composition on the negative current collector. Examples of the solvent include, for example, N-methylpyrrolidone, or water.

Hereinafter, a method of preparing the negative electrode for a rechargeable lithium battery according to an embodiment is described. The negative electrode may be prepared according to the following method.

First, the negative active material, the binder and the conductive material may be mixed with a solvent such as N-methylpyrrolidone to prepare a negative active material layer composition. The negative active material layer composition may be coated on the current collector to obtain a coated product, the coated product may be dried to obtain a dried product, and subsequently the dried product may be compressed in a multistep compression, preparing a high density negative electrode having a negative active material layer on the current collector.

The multistep compression may be the same as illustrated in the positive electrode and may be performed to obtain an active mass density of about 1.1 g/cc to about 2.29 g/cc following the final compression.

Hereinafter, a rechargeable lithium battery according to an embodiment is described. The rechargeable lithium battery may include the above positive electrode, or the above negative electrode, or may both the above positive electrode and the negative electrode.

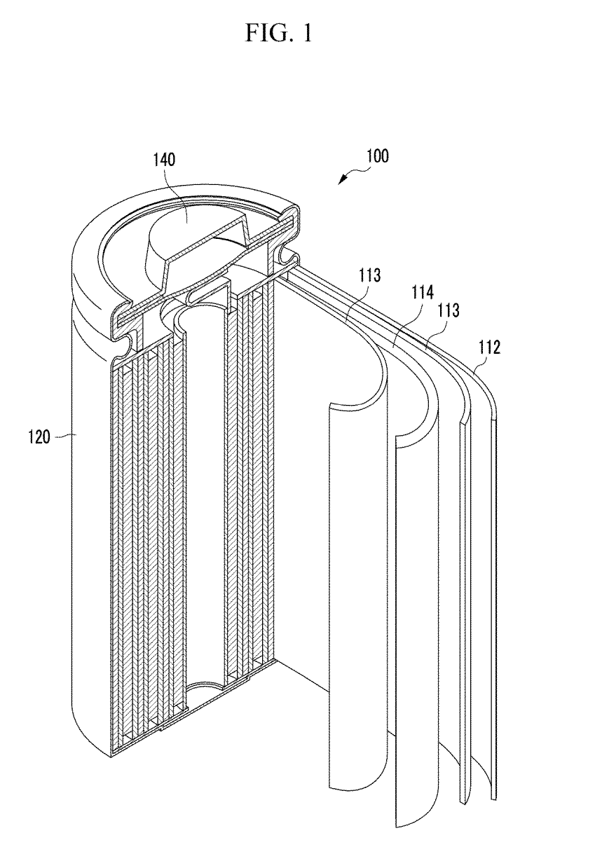

The rechargeable lithium battery is described referring to FIG. 1. FIG. 1 illustrates a schematic view of a rechargeable lithium battery according to an embodiment.

Referring to FIG. 1, a rechargeable lithium battery 100 according to an embodiment may include a positive electrode 114, a negative electrode 112 facing the positive electrode 114, a separator 113 interposed between the negative electrode 112 and the positive electrode 114, an electrolyte (not shown) impregnating the separator 113, a battery case 120, and a sealing member 140 sealing the battery case 120.

The positive electrode 114 may be the positive electrode, and the negative electrode 112 may be the negative electrode.

The electrolyte may include a lithium salt and an organic solvent. The lithium salt may be dissolved in a non-aqueous organic solvent, may supply lithium ions in a battery, may operate a basic operation of the rechargeable lithium battery, and may improve lithium ion transportation between positive and negative electrodes therein.

Examples of the lithium salt include LiPF₆, LiBF₄, LiSbF₆, LiAsF₆, LiN(SO₃C₂F₅)₂, LiN(CF₃SO₂)₂, LiC₄F₉SO₃, LiClO₄, LiAlO₂, LiAlCl₄, LiN(CₓF₂ₓ₊₁SO₂)(C_{y}F_{2y+1}SO₂) wherein, x and y are natural numbers, and e.g. an integer of 1 to 20, LiCl, LiI, LiB(C₂O₄)₂ (lithium bisoxalato borate (LiBOB), or a combination thereof.

The lithium salt may be used in a concentration ranging from about 0.1 M to about 2.0 M. Maintaining the lithium salt within the above concentration range may help provide an electrolyte having excellent performance and lithium ion mobility, for example, due to optimal electrolyte conductivity and viscosity.

The organic solvent serves as a medium for transmitting ions taking part in the electrochemical reaction of a battery. The organic solvent be selected from a carbonate-based, ester-based, ether-based, ketone-based, alcohol-based, or aprotic solvent.

The carbonate-based solvent may include, for example, dimethyl carbonate (DMC), diethyl carbonate (DEC), dipropyl carbonate (DPC), methylpropyl carbonate (MPC), ethylpropyl carbonate (EPC), methylethyl carbonate (MEC), ethylmethyl carbonate (EMC), ethylene carbonate (EC), propylene carbonate (PC), or butylene carbonate (BC).

For example, the linear carbonate compounds and cyclic carbonate compounds may be mixed, and an organic solvent having a high dielectric constant and a low viscosity may be provided. The cyclic carbonate compound and the linear carbonate compound may be mixed together in a volume ratio ranging from about 1:1 to about 1:9.

The ester-based solvent may be, for example, methylacetate, ethylacetate, n-propylacetate, dimethylacetate, methylpropionate, ethylpropionate, γ-butyrolactone, decanolide, valerolactone, mevalonolactone, or caprolactone. The ether-based solvent may be, for example, dibutylether, tetraglyme, diglyme, dimethoxyethane, 2-methyltetrahydrofuran, or tetrahydrofuran, and the ketone-based solvent may be, for example, cyclohexanone. The alcohol-based solvent may be, for example, ethanol or isopropyl alcohol.

The organic solvent may be used singularly or in a mixture, and when the organic solvent is used in a mixture, the mixture ratio may be controlled in accordance with a desirable battery performance.

The separator 113 may include any materials commonly used in the conventional lithium battery as long as separating a negative electrode 112 from a positive electrode 114 and providing a transporting passage for lithium ion. In other words, the separator 113 may have a low resistance to ion transportation and an excellent impregnation for an electrolyte solution. For example, the separator 113 may be selected from glass fiber, polyester, polyethylene, polypropylene, polytetrafluoroethylene (PTFE), or a combination thereof. The separator 113 may have a form of a non-woven fabric such as cellulose or a woven fabric. For example, a polyolefin-based polymer separator such as, for example, polyethylene or polypropylene may be used for a lithium ion battery. A coated separator including a ceramic component or a polymer material may help provide heat resistance or mechanical strength. Selectively, it may have a mono-layered or multi-layered structure.

The following Examples and Comparative Examples are provided in order to highlight characteristics of one or more embodiments, but it will be understood that the Examples and Comparative Examples are not to be construed as limiting the scope of the embodiments, nor are the Comparative Examples to be construed as being outside the scope of the embodiments. Further, it will be understood that the embodiments are not limited to the particular details described in the Examples and Comparative Examples.

### EXAMPLE 1

A negative active material layer composition was prepared by mixing 98 wt % of natural graphite, 1 wt % of carboxylmethyl cellulose (CMC) and 1 wt % of a styrene-butadiene rubber (SBR) and dispersing the mixture into water. The negative active material layer composition was coated on a 15 μm-thick copper foil, and then dried and compressed in multi-steps, preparing a negative electrode having active mass density of 1.7 g/cc. The multistep compression included a primary compression to obtain an active mass density of 1.2 g/cc, and subsequently, a secondary compression to obtain an active mass density of 1.7 g/cc.

The negative electrode and a lithium metal as its counter electrode were housed in a battery case, and an electrolyte solution was injected therein, preparing a rechargeable lithium battery cell. The electrolyte solution was prepared by mixing ethylenecarbonate (EC), diethylcarbonate (DEC) and fluoroethylenecarbonate (FEC) in a volume ratio of 5:70:25 and dissolving 1.15 M LiPF₆ in the mixed solvent.

### EXAMPLE 2

A rechargeable lithium battery cell was manufactured according to the same method as Example 1 except the primary compression was performed to obtain an active mass density of 1.2 g/cc, and subsequently, a secondary compression was performed to obtain an active mass density of 1.5 g/cc, and a third compression was performed to obtain an active mass density of 1.7 g/cc.

### COMPARATIVE EXAMPLE 1

A rechargeable lithium battery cell was manufactured according to the same method as Example 1 except the negative active material layer composition according to Example 1 was coated on a 15 μm-thick copper foil, and then dried and compressed once to manufacture a negative electrode having active mass density of 1.7 g/cc.

Evaluation 1: Pore Structure of Negative Electrode

Average pore size and porosity of the negative electrodes according to Examples 1 and 2 and Comparative Example 1 were measured in order to evaluate internal pore structure of the negative electrodes, and the results are provided in the following Table 1.

The total thickness of the negative active material layer is divided into a first region may be adjacent to the current collector and a second region may be separated from the current collector by the first region. Each of the first region and second region has a thickness equal to ½ of the total thickness of the negative active material layer. The first and second regions have first and second average pores, respectively.

TABLE 1

| | | | Comparative |
|---|---|---|---|
| | Example 1 | Example 2 | Example 1 |
| (A) First Average pore size (nm) | 150 | 150 | 300 |
| (B) Second Average pore size (nm) | 150 | 140 | 50 |
| (B)/(A) ratio | 1 | 0.93 | 0.17 |
| (C) Porosity of first region (%) | 19 | 19 | 28 |
| (D) Porosity of second region (%) | 19 | 18 | 11 |
| (D)/(C) ratio | 1 | 0.95 | 0.39 |

Evaluation 2: SEM photograph Analysis of Negative Electrode

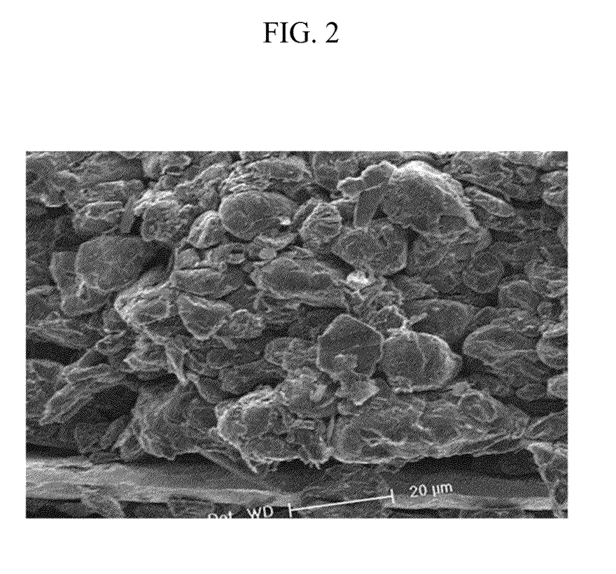

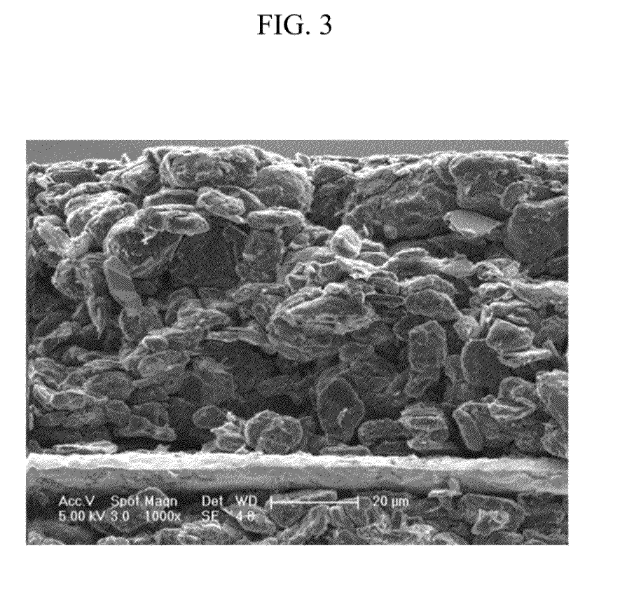

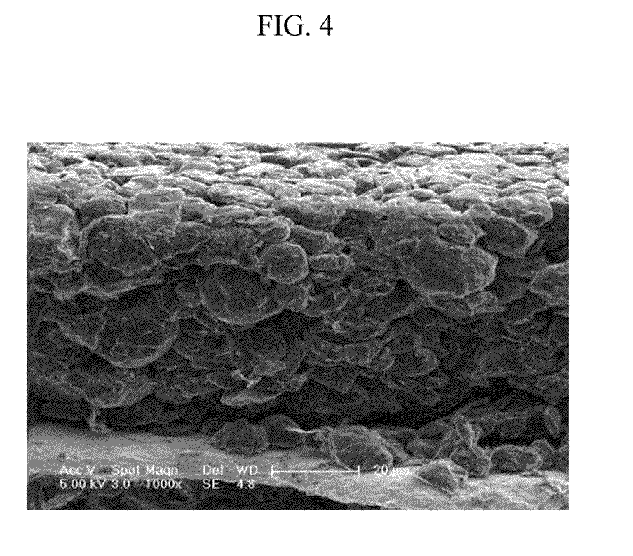

FIGS. 2 to 4 illustrate scanning electron microscope (SEM) photographs of inside of the negative electrodes for a rechargeable lithium battery according to Examples 1 and 2 and Comparative Example 1.

Referring to FIGS. 2 to 4, the negative electrode prepared through a single compression according to Comparative Example 1 had a different pore structure on the surface from that close to the current collector, since the surface of the negative electrode was mainly pushed down. On the other hand, the negative electrodes prepared through a multistep compression according to Examples 1 and 2 had an overall uniform pore structure.

Evaluation 3: Impregnation of Electrolyte Solution of Negative Electrode

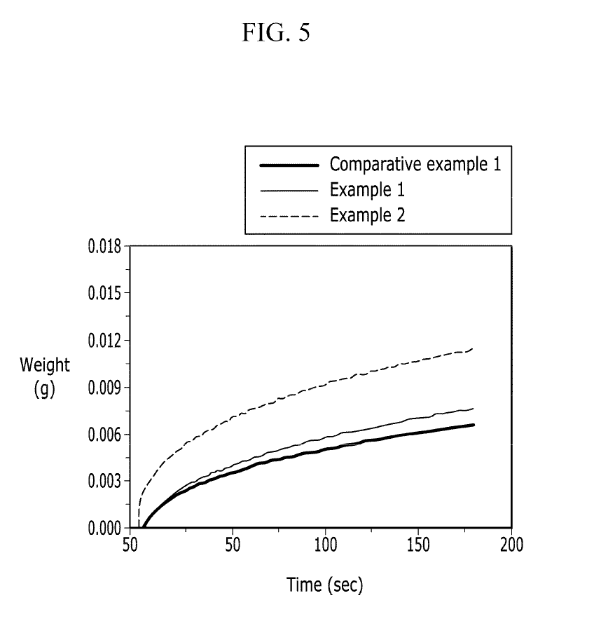

Impregnation characteristics of an electrolyte solution into the negative electrodes according to Examples 1 and 2 and Comparative Example 1 were evaluated by cutting each electrode into a size of 2 cm×2 cm, dipping it in the electrolyte solution, and measuring the amount of the electrolyte solution impregnated thereinto, and the results are provided in FIG. 5.

FIG. 5 illustrates a graph of impregnation properties of an electrolyte solution for the negative electrodes for a rechargeable lithium battery according to Examples 1 and 2 and Comparative Example 1.

Referring to FIG. 5, the negative electrodes prepared through a multistep compression according to Examples 1 and 2 exhibited improved impregnation characteristics of an electrolyte solution compared with the negative electrode prepared through a single compression according to Comparative Example 1.

### EXAMPLE 3

A positive active material layer composition was prepared by mixing 96 wt % of LiNi_{1/3}Co_{1/3}Mn_{1/3}O₂·Li₂MnO₃ (mixing weight ratio of LiNi_{1/3}Co_{1/3}Mn_{1/3}O₂·:Li₂MnO₃ was 50:50), 2 wt % of polyvinylidene fluoride (PVdF) and 2 wt % of carbon black and dispersing the mixture into N-methylpyrrolidone. The positive active material layer composition was coated on a 20 μm-thick aluminum foil, and then dried and compressed in a multistep compression, preparing a positive electrode having active mass density of 2.35 g/cc. The multistep compression included a primary compression to obtain an active mass density of 2.2 g/cc, and subsequently, a secondary compression to obtain an active mass density of 2.35 g/cc.

The positive electrode and lithium metal as its counter electrode were housed into a battery case, and an electrolyte solution was injected thereinto, preparing a rechargeable lithium battery cell. The electrolyte solution was prepared by mixing ethylenecarbonate (EC), diethylcarbonate (DEC) and fluoroethylenecarbonate (FEC) in a volume ratio of 5:70:25 and dissolving 1.15 M LiPF₆ in the mixed solvent.

### EXAMPLE 4

A rechargeable lithium battery cell was manufactured according to the same method as Example 3 except a positive electrode having active mass density of 2.45 g/cc was prepared through a multistep compression. The multistep compression included a primary compression to obtain an active mass density of 2.2 g/cc, and subsequently, a secondary compression to obtain an active mass density of 2.45 g/cc.

### EXAMPLE 5

A rechargeable lithium battery cell was manufactured according to the same method as Example 3 except a positive electrode having active mass density of 2.65 g/cc was prepared through a multistep compression. The multistep compression included a primary compression to obtain an active mass density of 2.2 g/cc, and subsequently, a secondary compression to obtain an active mass density of 2.65 g/cc.

### COMPARATIVE EXAMPLE 2

A rechargeable lithium battery cell was manufactured according to the same method as Example 3 except for the positive active material layer composition of Example 3 was coated on a 20 μm-thick aluminum foil, and then dried and compressed once to manufacture a positive electrode having active mass density of 2.35 g/cc.

### COMPARATIVE EXAMPLE 3

A rechargeable lithium battery cell was manufactured according to the same method as Example 3 except the positive active material layer composition of Example 3 was coated on a 20 μm-thick aluminum foil, and then dried and compressed once to manufacture a positive electrode having active mass density of 2.45 g/cc.

### COMPARATIVE EXAMPLE 4

A rechargeable lithium battery cell was manufactured according to the same method as Example 3 except the positive active material layer composition of Example 3 was coated on a 20 μm-thick aluminum foil, and then dried and compressed once to manufacture a positive electrode having active mass density of 2.65 g/cc.

Evaluation 4: Pore Structure of Positive Electrode

Internal pore structure of the positive electrodes according to Examples 3 to 5 and Comparative Examples 2 to 4 was evaluated by measuring their average pore size and porosity, and the results are provided in the following Table 2.

The total thickness of the positive active material layer is divided into a first region may be adjacent to the current collector and a second region may be separated from the current collector by the first region. Each of the first region and second region has a thickness equal to ½ of the total thickness of the positive active material layer. The first and second regions have first and second average pores, respectively.

TABLE 2

| | | | | Comparative | | |
|---|---|---|---|---|---|---|
| | Example | | | Example | | |
| | 3 | 4 | 5 | 2 | 3 | 4 |
| (A) First average | 100 | 83 | 61 | 135 | 122 | 112 |
| pore size (nm) | | | | | | |
| (B) Second average | 100 | 80 | 60 | 60 | 32 | 25 |
| pore size (nm) | | | | | | |
| (B)/(A) ratio | 1 | 0.96 | 0.98 | 0.44 | 0.26 | 0.22 |
| (C) Porosity of | 38 | 35 | 31 | 51 | 50 | 50 |
| first region (%) | | | | | | |
| (D) Porosity of | 38 | 35 | 30 | 25 | 20 | 10 |
| second region (%) | | | | | | |
| (D)/(C) ratio | 1 | 1 | 0.97 | 0.49 | 0.4 | 0.2 |

Evaluation 5: SEM photograph Analysis of Positive Electrode

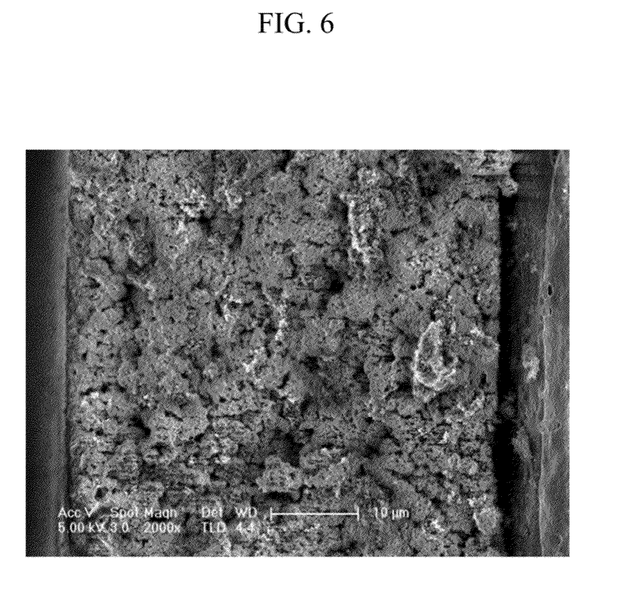

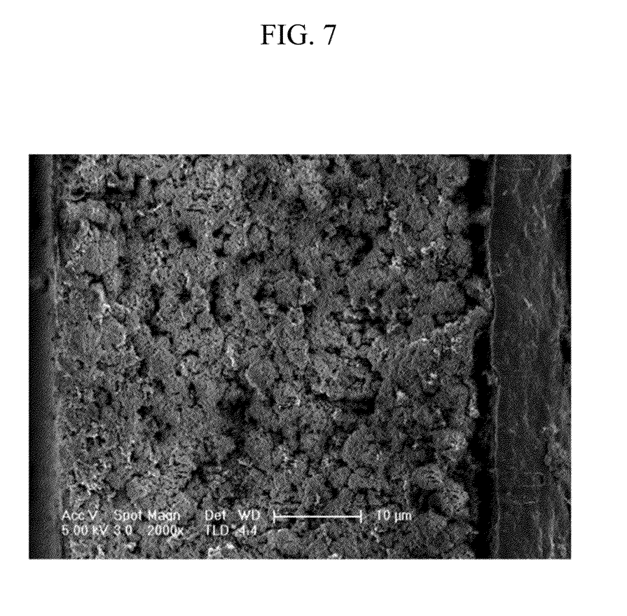

FIGS. 6 and 7 illustrate scanning electron microscope (SEM) photographs of inside of the positive electrodes for a rechargeable lithium battery according to Example 3 and Comparative Example 2.

Referring to FIGS. 6 and 7, the positive electrode prepared through a single compression according to Comparative Example 2 had a different pore structure in the surface region (a right region) from that in a region close to the current collector (a left region), since the surface region is mainly pushed down. On the other hand, the positive electrode prepared through a multistep compression according to Example 3 had an overall uniform pore structure.

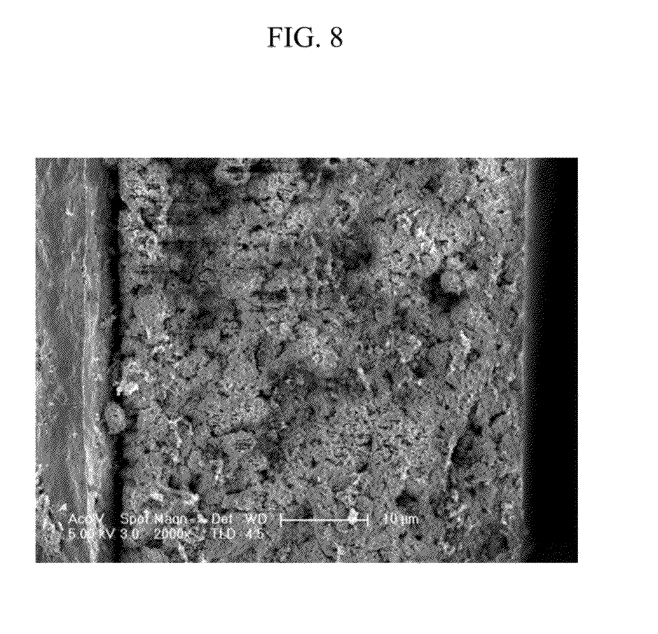

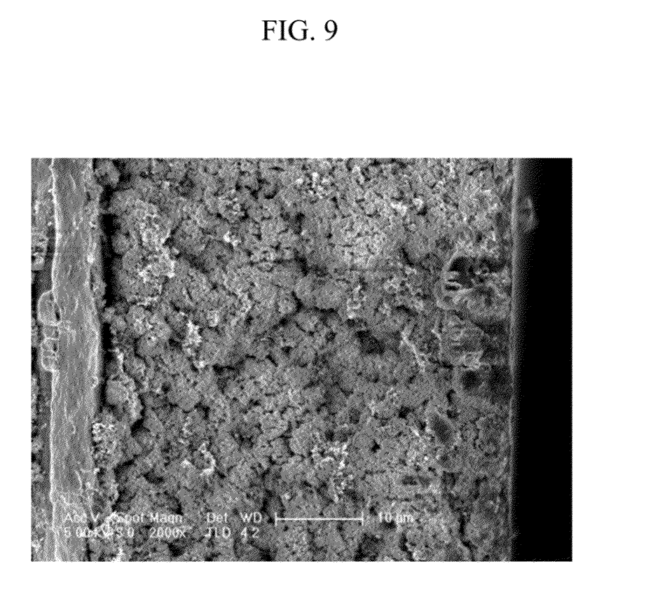

FIGS. 8 and 9 illustrate scanning electron microscope (SEM) photographs of inside of the positive electrodes for a rechargeable lithium battery according to Example 4 and Comparative Example 3.

Referring to FIGS. 8 and 9, the positive electrode prepared through a multistep compression according to Example 4 had an overall uniform pore structure compared with the positive electrode prepared through a single compression according to Comparative Example 3.

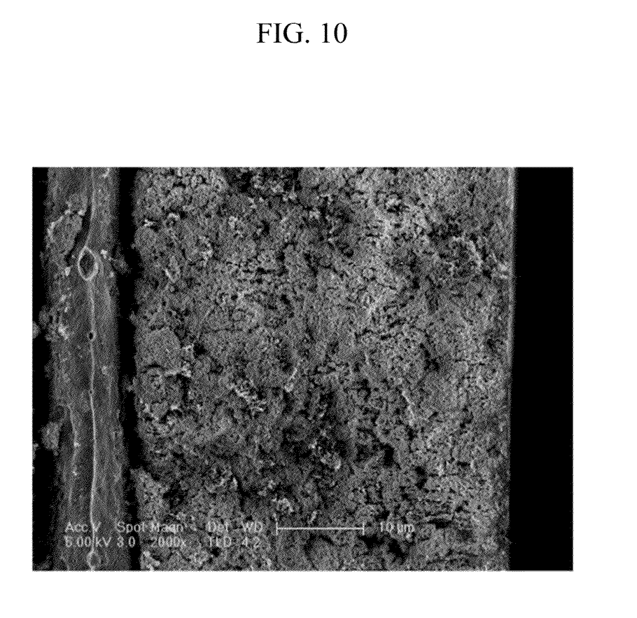

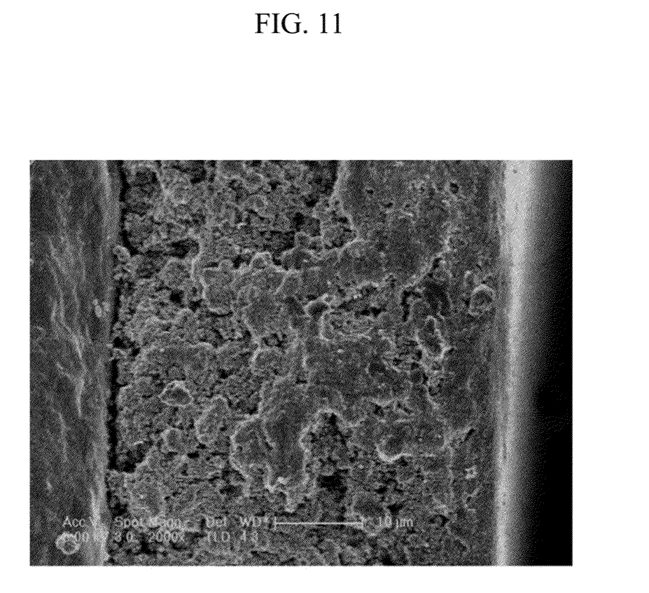

FIGS. 10 and 11 illustrate scanning electron microscope (SEM) photographs of inside of the positive electrodes for a rechargeable lithium battery according to Example 5 and Comparative Example 4.

Referring to FIGS. 10 and 11, the positive electrode prepared through a multistep compression according to Example 5 had an overall uniform pore structure compared with the positive electrode prepared through a single compression according to Comparative Example 4.

Evaluation 6: Pore Distribution of Positive Electrode

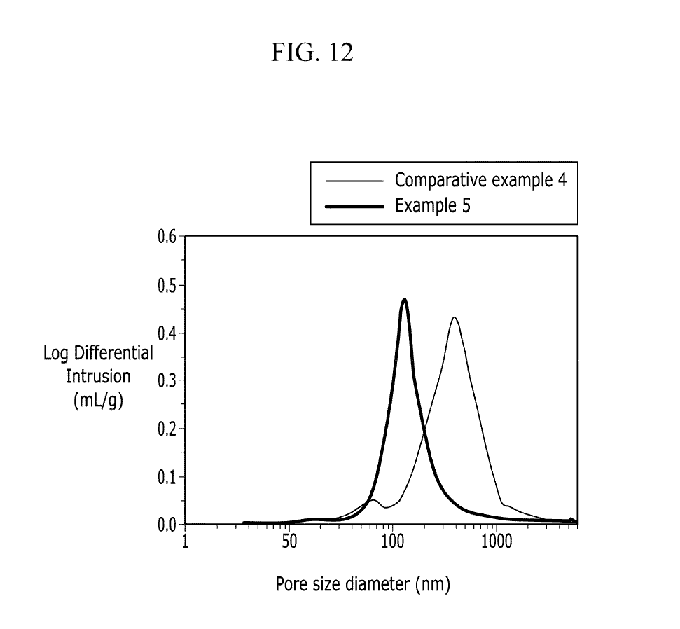

FIG. 12 illustrates a graph of a pore distribution inside the positive electrodes for a rechargeable lithium battery according to Example 5 and Comparative Example 4.

Referring to FIG. 12, the positive electrode prepared through a multistep compression according to Example 5 exhibited one peak, and its average pore size distribution was decreased compared with the positive electrode prepared through a single compression according to Comparative Example 4. Based on the result, the positive electrode of Example 5 exhibited a uniform pore structure compared with that of Comparative Example 4.

Evaluation 7: Impregnation of Electrolyte Solution of Positive Electrode

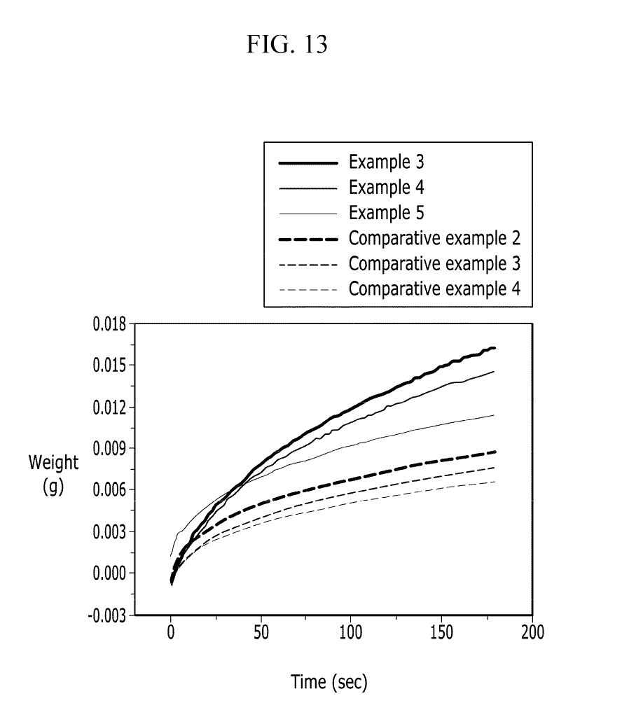

Impregnation characteristics of an electrolyte solution into the positive electrodes according to Examples 3 to 5 and Comparative Examples 2 to 4 were evaluated by cutting each electrode into a size of 1 cm×1 cm, dipping it in an electrolyte solution, and measuring the amount of the electrolyte solution impregnated into the electrode plate, and the results are provided in FIG. 13.

FIG. 13 illustrates a graph of impregnation properties of an electrolyte solution for the positive electrodes for a rechargeable lithium battery according to Examples 3 to 5 and Comparative Examples 2 to 4.

Referring to FIG. 13, the positive electrodes prepared through a multistep compression according to Examples 3 to 5 exhibited improved impregnation characteristics of an electrolyte solution compared with the positive electrodes prepared through a single compression according to Comparative Examples 2 to 4.

Evaluation 8: Cycle-life Characteristics of Rechargeable Lithium Battery

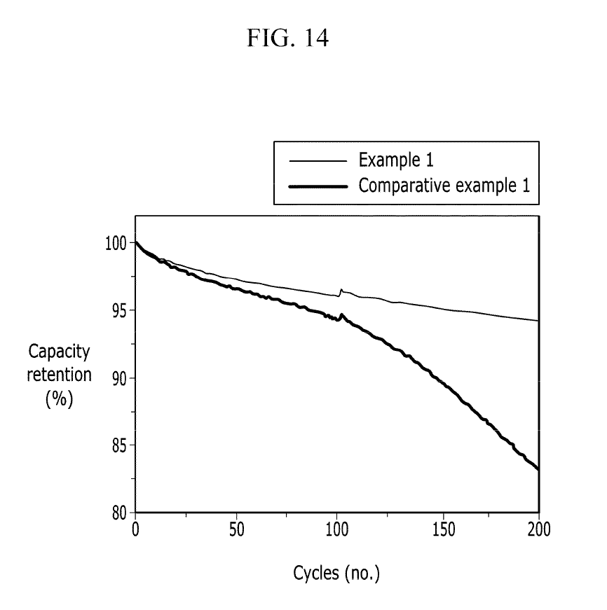

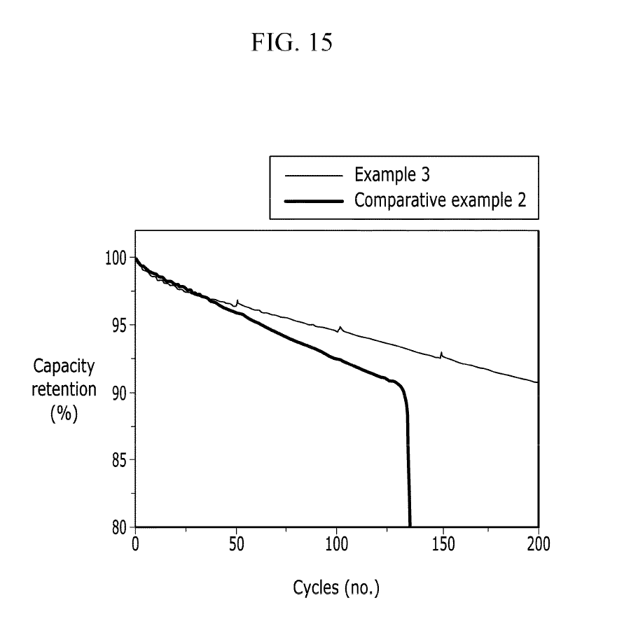

The rechargeable lithium battery cells according to Examples 1 and 3 Comparative Examples 1 and 2 were charged and discharged in the following method, and the results are provided in FIGS. 14 and 15.

The charge and discharge were 200 times repeated in a voltage range of 2.8 V to 4.2 V under a condition of 1 C charge and 1 C discharge.

FIG. 14 illustrates a graph of cycle-life characteristics of the rechargeable lithium battery cells according to Example 1 and Comparative Example 1, and FIG. 15 illustrates a graph of cycle-life characteristics of the rechargeable lithium battery cells according to Example 3 and Comparative Example 2.

Referring to FIG. 14, the positive electrode prepared through a multistep compression according to Example 1 exhibited excellent cycle-life characteristics compared with the positive electrode prepared through a single compression according to Comparative Example 1. Referring to FIG. 15, the positive electrode prepared through a multistep compression according to Example 3 exhibited excellent cycle-life characteristics compared with the positive electrode prepared through a single compression according to Comparative Example 2.

By way of summation and review, a compressed electrode may exhibit more severe internal non-uniformity as density of the electrode is increased. An embodiment provides a positive electrode for a rechargeable lithium battery that may have improved impregnation characteristics of an electrolyte, for example, due to a uniform pore structure even inside a high-density positive electrode, and that may have improved cycle-life characteristics. An embodiment provides a method of preparing the positive electrode for a rechargeable lithium battery. An embodiment provides a negative electrode for a rechargeable lithium battery that may have improved impregnation characteristics of an electrolyte, for example, due to a uniform pore structure even inside a high-density negative electrode, and improved cycle-life characteristics. An embodiment provides a method of preparing the negative electrode for a rechargeable lithium battery. Impregnation characteristics of an electrolyte may be improved, for example, due to a uniform pore structure even inside a high-density electrode, and a rechargeable lithium battery having improved cycle-life characteristics may be realized.

Example embodiments have been disclosed herein, and although specific terms are employed, they are used and are to be interpreted in a generic and descriptive sense only and not for purpose of limitation. In some instances, as would be apparent to one of skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A positive electrode for a rechargeable lithium battery, comprising:
a current collector; and
a positive active material layer on the current collector,
the positive active material layer having a first region adjacent to the current collector and a second region separated from the current collector by the first region, each of the first region and second region having a thickness equal to ½ of a total thickness of the positive active material layer,
the first region having a first average pore size, the second region having a second average pore size,
a ratio of the second average pore size to the first average pore size being greater than about 0.5 and less than or equal to about 1.0, and
the positive electrode having an active mass density of about 2.3 g/cc to about 4.5 g/cc.

2. The positive electrode for a rechargeable lithium battery as claimed in claim 1, wherein:
the first average pore size is about 20 nm to about 1000 nm, and
the second average pore size is about 10 nm to about 1000 nm.

3. The positive electrode for a rechargeable lithium battery as claimed in claim 1, wherein a ratio of a porosity of the second region to a porosity of the first region is greater than about 0.5 and less than or equal to about 1.0.

4. The positive electrode for a rechargeable lithium battery as claimed in claim 1, wherein:
a porosity of the first region is about 5 volume % to about 40 volume %, and
a porosity of the second region is about 5 volume % to about 40 volume %.

5. A method of preparing a positive electrode for a rechargeable lithium battery, comprising:
coating a positive active material layer composition on a current collector to obtain a coated product;
drying the coated product to obtain a dried product; and
compressing the dried product in a multistep compression, the multistep compression providing different active mass densities of the positive electrode following each compression and a final active mass density of the positive electrode of about 2.3 g/cc to about 4.5 g/cc.

6. The method as claimed in claim 5, wherein the multistep compression includes increasing the active mass density of the positive electrode with successive compressions.

7. A negative electrode for a rechargeable lithium battery, comprising:
a current collector; and
a negative active material layer on the current collector,
the negative active material layer having a first region adjacent to the current collector and a second region separated from the current collector by the first region, each of the first region and second region having a thickness equal to ½ of a total thickness of the negative active material layer,
the first region having a first average pore size, the second having including a second average pore size,
a ratio of the second average pore size to the first average pore size being greater than about 0.5 and less than or equal to about 1.0, and
the negative electrode having an active mass density of about 1.1 g/cc to about 2.29 g/cc.

8. The negative electrode for a rechargeable lithium battery as claimed in claim 7, wherein:
the first average pore size is about 20 nm to about 1000 nm, and
the second average pore size is about 10 nm to about 1000 nm.

9. The negative electrode for a rechargeable lithium battery as claimed in claim 7, wherein a ratio of a porosity of the second region to a porosity of the first region is greater than about 0.5 and less than or equal to about 1.0.

10. The negative electrode for a rechargeable lithium battery as claimed in claim 7, wherein:
a porosity of the first region is about 5 volume % to about 40 volume %, and
a porosity of the second region is about 5 volume % to about 40 volume %.

11. A method of preparing a negative electrode for a rechargeable lithium battery, comprising:
coating a negative active material layer composition on a current collector to obtain a coated product;
drying the coated product to obtain a dried product; and
compressing the dried product in a multistep compression, the multistep compression providing different active mass densities of the negative electrode following each compression and a final active mass density of the negative electrode of about 1.1 g/cc to about 2.29 g/cc.

12. The method as claimed in claim 11, wherein the multistep compression includes increasing active mass density of the negative electrode with successive compressions.
